(19) United States
(12) Patent Application Publication
(10) Pub. No.: US 2024/0429454 A1
(43) Pub. Date: Dec. 26, 2024

(54) SOLID-STATE LITHIUM BATTERY

(71) Applicant: Institute of Nuclear Energy Research, Atomic Energy Council, Executive Yuan, R.O.C, Taoyuan (TW)

(72) Inventors: TIEN-HSIANG HSUEH, Taoyuan (TW); SHANG-EN LIU, Taoyuan (TW); MIN-CHUAN WANG, Taoyuan (TW); TING-KUEI TSAI, Taoyuan (TW); YU-LIN YEH, Taoyuan (TW); YU-CHEN LI, Taoyuan (TW); BO-HSIEN WU, Taoyuan (TW)

(21) Appl. No.: 18/234,010

(22) Filed: Aug. 15, 2023

(30) Foreign Application Priority Data
Jun. 21, 2023 (TW) 112123359

(51) Int. Cl. H01M 10/0585; H01M 4/131; H01M 4/134; H01M 4/38; H01M 4/48; H01M 10/052; H01M 10/0562; H01M 10/0565; H01M 10/42

(52) U.S. Cl. CPC H01M 10/0585; H01M 4/131; H01M 4/134; H01M 4/38; H01M 4/483; H01M 10/052; H01M 10/0562; H01M 10/0565; H01M 10/4235; H01M 2004/021; H01M 2300/0068; H01M 2300/0082; H01M 2300/0094

(57) ABSTRACT

A solid-state lithium battery includes a solid electrolyte layer, a first electrode layer structure, a second electrode layer structure, a first collector layer and a second collector layer. The first electrode layer structure includes a first buffer electrolyte layer and a first microporous electrode layer. The first buffer electrolyte layer is located between the first microporous electrode layer and the first surface of the solid electrolyte layer. The first buffer electrolyte layer is embedded with the first surface of the solid electrolyte layer. The second electrode layer structure is disposed on the second surface of the solid electrolyte layer. The first microporous electrode layer is disposed between the first collector layer and first buffer electrolyte layer. The second electrode layer structure is disposed between the second collector layer and the second surface of the solid electrolyte layer.

### CROSS REFERENCE TO RELATED APPLICATION

All related applications are incorporated by reference. The present application is based on, and claims priority from, Taiwan Application Serial Number 112123359, filed on Jun. 21, 2023, the disclosure of which is hereby incorporated by reference herein in its entirety.

### TECHNICAL FIELD

The instant invention is related to a solid-state lithium battery.

### BACKGROUND

With the improvement of technology and the discovery of new materials, a variety of batteries have developed. With the development of mobile phones, notebook computers, and electric vehicles, the demand for lithium batteries is increasing. Among the electrochemical components in such as primary batteries or secondary batteries and capacitors, liquid electrolytes are mostly used as ion-conducting materials for the manufacture of new batteries. However, liquid electrolytes have several disadvantages such as electrolyte leakage, lack of long-term stability, susceptibility to corrosion, high flammability, poor safety and low reliability, etc. So, the liquid electrolytes cannot satisfy the safety requirements of modern large-scale industrial energy storage. The defective batteries may cause explosions in devices such as mobile phones.

Besides, with the rise of new energy vehicles, spontaneous combustion and explosion incidents of lithium batteries have emerged one after another. However, in addition to the poor ion-conductivity, currently the pure solid-state electrolytes lithium batteries can only be charged and discharged normally under high temperature or high pressure conditions because of the high interface impedance. Therefore, how to improve the above-mentioned encountered problems will be one of the issues to be solved in the industry.

### SUMMARY

The instant disclosure provides a solid-state lithium battery, which reduces the interface impedance, enables the solid-state lithium battery to be charged, discharged and used under normal temperature and pressure conditions, and improves the charging and discharging efficiency.

The instant disclosure provides a solid-state lithium battery, which includes a solid electrolyte layer, a first electrode layer structure, a second electrode layer structure, a first collector layer and a second collector layer. The solid electrolyte layer includes a first surface and a second surface opposite to each other. The first electrode layer structure includes a first buffer electrolyte layer and a first microporous electrode layer. The first buffer electrolyte layer is located between the first microporous electrode layer and the first surface of the solid electrolyte layer. The first buffer electrolyte layer is embedded with the first surface of the solid electrolyte layer. The second electrode layer structure is disposed on the second surface of the solid electrolyte layer. The first microporous electrode layer is disposed between the first collector layer and first buffer electrolyte layer. The second electrode layer structure is disposed between the second collector layer and the second surface of the solid electrolyte layer.

In one embodiment of the instant disclosure, the first buffer electrolyte layer includes an electrolyte material.

In one embodiment of the instant disclosure, the electrolyte material is a polymer gel electrolyte (PGE).

In one embodiment of the instant disclosure, the first buffer electrolyte layer includes an ion-conductive material.

In one embodiment of the instant disclosure, the first buffer electrolyte layer includes a flame retardant (FR) substance.

In one embodiment of the instant disclosure, the second electrode layer structure is an electrode layer.

In one embodiment of the instant disclosure, the thickness of the first microporous electrode layer is greater than five times the thickness of the second electrode layer structure.

In one embodiment of the instant disclosure, the first buffer electrolyte later is a hot-melt type ion-conductive polymer gel electrolyte.

In one embodiment of the instant disclosure, the first buffer electrolyte is a solvent type ion-conductive polymer gel electrolyte.

In one embodiment of the instant disclosure, the second electrode layer structure includes a second buffer electrolyte layer, and the second buffer electrolyte layer is embedded with the second surface of the solid electrolyte layer.

In one embodiment of the instant disclosure, the second electrode layer structure includes an active metal electrode layer, and the second buffer electrolyte layer is located between the active metal electrode layer and the second surface of the solid electrolyte layer.

In one embodiment of the instant disclosure, the second electrode layer structure includes a second microporous electrode layer, and the second buffer electrolyte layer is located between the second microporous electrode layer and the second surface of the solid electrolyte layer.

In one embodiment of the instant disclosure, the second microporous electrode layer includes an active metal.

In one embodiment of the instant disclosure, the thickness of the first microporous electrode layer is greater than five times the thickness of the second electrode

In one embodiment of the instant disclosure, the first buffer electrolyte layer and the second buffer electrolyte layer respectively include an electrolyte material.

In one embodiment of the instant disclosure, the electrolyte material of the first buffer electrolyte layer is the same as the electrolyte material of the second buffer electrolyte layer.

In one embodiment of the instant disclosure, the electrolyte material of the first buffer electrolyte layer is different from the electrolyte material of the second buffer electrolyte layer.

In one embodiment of the instant disclosure, the electrolyte material of the first buffer electrolyte layer and the electrolyte material of the second buffer electrolyte layer are respectively a polymer gel electrolyte.

In one embodiment of the instant disclosure, the first buffer electrolyte layer and the second buffer electrolyte layer respectively include an ion-conductive material.

In one embodiment of the instant disclosure, the ion-conductive material of the first buffer electrolyte layer is the same as the ion-conductive material of the second buffer electrolyte layer.

In one embodiment of the instant disclosure, the ion-conductive material of the first buffer electrolyte layer is different from the ion-conductive material of the second buffer electrolyte layer.

In one embodiment of the instant disclosure, the first buffer electrolyte layer and the second buffer electrolyte layer respectively include a flame retardant substance.

In one embodiment of the instant disclosure, the second buffer electrolyte layer is a hot-melt type ion-conductive polymer gel electrolyte.

In one embodiment of the instant disclosure, the second buffer electrolyte layer is a solvent type ion-conductive polymer gel electrolyte.

In one embodiment of the instant disclosure, the first microporous electrode layer includes an oxide containing lithium and transition metal.

In one embodiment of the instant disclosure, the second microporous electrode layer includes an oxide containing lithium and transition metal.

Based on the above, the instant disclosure applies the use of the first buffer electrolyte layer to connect with the first microporous electrode layer and the solid electrolyte layer, and the function of the ion channel of the second electrode layer structure to prevent the solid electrolyte layer from reacting with the active material, which results in the formation of a high-impedance solid electrolyte interface. Thus, it can also prevent the active material from leading the formation of lithium dendrites during charging/discharging process and penetrate the layer resulting in a short circuit. In other words, the use of the first buffer electrolyte layer can solve the problem of high-impedance interface of the solid electrolyte layer, so there is no need to charge/discharge under high temperature or high pressure conditions. The solid state lithium battery of the instant disclosure can be charged, discharged and used under regular temperature and pressure.

In addition, the structure of the first microporous electrode layer can retain the ion channel unblocked and maintain the battery performance when the battery body is expanding or shrinking due to charge/discharge process.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1 is a schematic diagram of an embodiment of a solid-state lithium battery disclosed in the instant disclosure.

FIG. 2 is a schematic diagram of another embodiment of the solid-state lithium battery disclosed in the instant disclosure.

FIG. 3 is a schematic diagram of yet another embodiment of the solid-state lithium battery disclosed in the instant disclosure.

### DETAILED DESCRIPTION

Exemplary embodiments of the solid-state lithium battery of the instant disclosure will be described below with reference to the accompanying drawings. To clearly and fully convey the scope of the instant invention, the components in the drawings may be presented exaggeratedly or reduced in size or proportion, and the same components in the embodiments will be described with the same symbols.

Terms such as “including”, “comprising”, and “having” used in this disclosure are all open terms, which means “including but not limited to”. In the description of various embodiments, when terms such as “first”, “second”, “third”, “fourth” etc. are used to describe elements, they are only used to distinguish these elements from each other but not used to limit the order or importance of these elements. In the description of various embodiments, the so-called “coupling” or “connection” may refer to two or more elements being in direct physical or electrical contact with each other, or indirect physical or electrical contact with each other. The “coupling” or “connection” may also refer to two or more elements operating or acting with each other.

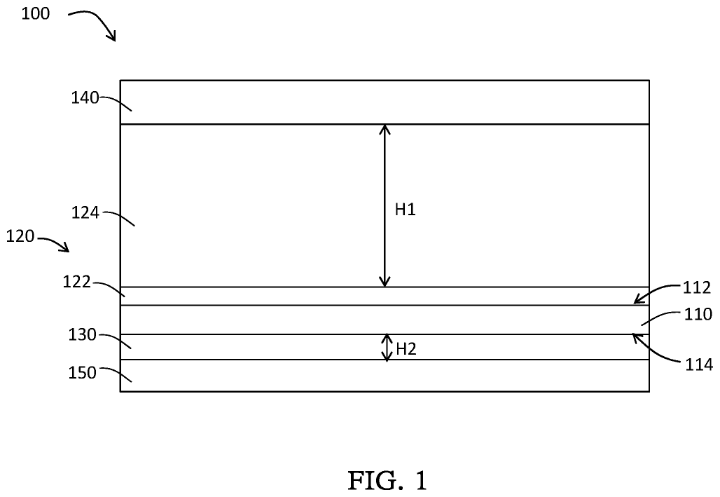

Please refer to FIG. 1, which is a schematic diagram of an embodiment of a solid-state lithium battery disclosed in the present disclosure. The solid-state lithium battery 100 of the instant disclosure includes a solid electrolyte layer 110, a first electrode layer structure 120, a second electrode layer structure 130, a first collector layer 140, and a second collector layer 150. The solid electrolyte layer 110 includes a first surface 112 and a second surface 114 opposite to each other. The first electrode layer structure 120 includes a first buffer electrolyte layer 122 and a first microporous electrode layer 124. The first buffer electrolyte layer 122 is located between the first microporous electrode layer 124 and the first surface 112 of the solid electrolyte layer 110. The first buffer electrolyte layer 122 is embedded with the first surface 122 of the solid electrolyte layer 110. The second electrode layer structure 130 is disposed on the second surface 114 of the solid electrolyte layer 110. In other words, the first electrode layer structure 120 and the second electrode layer structure 130 are disposed respectively on opposite sides of the solid electrolyte layer 110. The first microporous electrode layer 124 and the second electrode layer structure 130 serve as electrodes, and the material of them may include active materials and conductive materials. The active materials may include but not limit to high-reactivity metal, high-reactivity metallic alloys, graphite, graphene, active carbon. The first microporous electrode layer 124 is disposed between the first collector layer 140 and the first buffer electrolyte layer 122. The second electrode layer structure 130 is disposed between the second collector layer 150 and the second surface 114 of the solid electrolyte layer 110. Wherein the first collector layer 140 and the second collector layer 150 can respectively be made of conductive materials such as Ag, Cu, Ni, Co, Al, Au, Pt, and stainless. In one embodiment, in addition to being as conductive material, the first collector layer 140 and the second collector layer 150 include a substrate, which can be made of Al, Cu, Ni, mica sheets, and polymers (such as PET and PI) etc., and can be used as support and carriers for active materials. In another embodiment, the first collector layer 140 and the second collector layer 150 themselves are substrates.

In the instant disclosure, the first electrode layer structure 120 composed of the first buffer electrolyte layer 122 and the first microporous electrode layer 124 is disposed on the first surface 112 of the solid electrolyte layer 110. Wherein the first buffer electrolyte layer 122 can be embedded with the first surface 112 of the solid electrolyte layer 110 by coating or pasting. The instant disclosure applies the use of the first buffer electrolyte layer 122 to connect with the first microporous electrode layer 124 and the solid electrolyte layer 110, and the function of the ion channel of the second electrode layer structure 130 to prevent the solid electrolyte layer 110 from reacting with the active material (the first microporous electrode layer 124 or the second electrode layer structure 130) of which results in the formation of a high-impedance solid electrolyte layer 110 interface. By thus, it can also prevent the active material from leading the formation of lithium dendrites during charging/discharging process to penetrate the layer resulting in a short circuit. In other words, the use of the first buffer electrolyte layer 122 can solve the problem of high-impedance interface of the solid electrolyte layer 110, so there is no need to charge/discharge the solid-state lithium battery 100 under high temperature or high pressure conditions. The solid-state lithium battery 100 of the instant disclosure can be charged, discharged and used under regular temperature and pressure. In addition, the structure of the first microporous electrode layer 124 can retain the unblock ion channel and maintain the battery performance when the battery body is expanding or shrinking due to the charge/discharge process.

In one embodiment, the material of the solid electrolyte layer 110 includes: Li_{0.34}La_{0.51}TiO_{2.94} (LLTO), Li₇La₃Zr₂O₁₂ (LLZO), Li_{1.3}Al_{0.3}Ti_{1.7}(PO₄)₃(LATP), Li₁₀SnP₂S₁₂ (LSPS), Li₆PS₅Cl (LPSC), LUn₁−xGe₀₄ (LISI(₃)N), Li₂S, Li₂S—P₂S₅, Li₂S—SiS₂, Li₂S—GeS₂, Li₂S—B₂S₅, Li₂S—Al₂S₅, Li_{3.25}Ge_{0.25}P_{0.75}S₄ (Sulfur-substituted LISICON), Li₃N, LiPON, doped-LiPON (ex: Fe-doped LiPON), and the group consisting those mentioned above.

In one embodiment, the first buffer electrolyte layer 122 includes an electrolyte material, which is a polymer gel electrolyte, so that the first buffer electrolyte layer 122 is a material with softness and high adhesion. That is to say, the first buffer electrolyte layer 122 of the instant disclosure possesses plasticity and flexibility at room temperature and has better contact, and is more suitable as a part of the battery structure. Therefore, the morphology of the first buffer electrolyte layer 122 embedded with the first surface 112 of the solid electrolyte layer 110 can be changed in accordance with the morphology of the electrode sheet within the temperature range of 0° C. to 90° C.

In one embodiment, the first buffer electrolyte layer 122 includes an ion-conducting material, so that the buffer layer of the present disclosure (such as the first buffer electrolyte layer 122) has the function of conducting ions.

In one embodiment, the first buffer electrolyte layer 122 can be a hot-melt type ion-conductive polymer gel electrolyte. The hot-melt type polymer gel electrolyte includes a group of compounds selected from polyethylene (PE), polypropylene (PP), polystyrene (PS), polymethyl methacrylate (PMMA), polyvinyl chloride (PVC), Nylon, polycarbonate (PC), polyurethane (PU), polytetrafluoroethylene (PTFE), polyethylene terephthalate (PET), Polyacrylonitrile (PAN), polyetherimide (PEI), polysulfone (PSU), polyethersulfone (PES), polyaniline, polyphenylene sulfone, polyphenylene sulfone resins (PPSU), ethylene carbonate, polypropylene carbonate, dimethoxyethane, dimethyl carbonate, ethyl methyl carbonate, sulfolane, succinonitrile, lithium hexafluorophosphate (LiPF₆), lithium perchlorate (LiClO₄), lithium phosphate (Li₃PO₄) and bistrifluoro lithium methanesulfonyl imide (LiTFSI).

In another embodiment of the instant disclosure, the first buffer electrolyte is a solvent type ion-conductive polymer gel electrolyte. The solvent type ion-conductive polymer gel electrolyte may include a group of compounds selected from polyethylene oxide (PEO), polypropylene oxide (PPO), polysiloxanes, polyvinylidene fluoride (PVDF), poly(vinylidene fluoride-co-hexafluoropropylene) (PVDF-HFP), polyetherimide (PEI), polysulfone (PSU), polyethersulfone (PES), Polyphenylene sulfone resins (PPSU), Ethylene carbonate, polypropylene carbonate, dimethoxyethane, dimethyl carbonate, ethyl methyl carbonate, sulfolane, succinonitrile, lithium hexafluorophosphate (LiPF₆), lithium perchlorate (LiClO₄), lithium phosphate (Li₃PO₄), lithium bis(trifluoromethanesulfonyl) imide (LiTFSI), polyaniline, polyphenylene sulfone, acetone and ethanol.

In one embodiment of the instant disclosure, the first buffer electrolyte layer 122 includes a flame retardant (FR) substance, so that the solid-state lithium battery 100 of the instant disclosure possesses a flame retardant property.

In one embodiment of the instant disclosure, the first microporous electrode layer 124 includes an oxide containing lithium and transition metal. The first microporous electrode layer 124 can be formed on the first buffer electrolyte layer 122 by coating or spraying, and the first microporous electrode layer 124 is a structure with a plurality of micropores, which has conductive or semiconductive properties, and most of them can be used in positive electrode as example. For example, the first electrode layer structure 120 of this embodiment serves as a positive electrode, and the second electrode layer structure 130 serves as a negative electrode. In addition, in one embodiment, the thickness H1 of the first microporous electrode layer 124 is greater than five times the thickness H2 of the second electrode layer structure 130, so that the overall capacitance density can be increased.

The second electrode layer structure 130 in FIG. 1 is an electrode layer, that is to say, in this embodiment, the first electrode layer structure 120 is used as the positive electrode, which includes the first buffer electrolyte layer 122 and the first microporous electrode layer 124, and disposed on one side of the solid electrolyte layer 110, so as to improve the problems of the conventional technology.

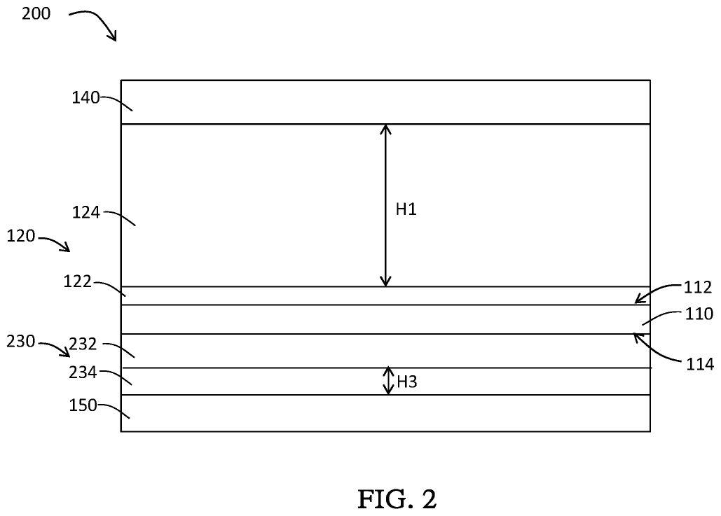

However, the instant disclosure is not limited thereto, the structures of the first buffer electrolyte layer 122 and the first microporous electrode layer 124 can also be disposed on opposite sides of the solid electrolyte 110, as shown in FIG. 2. FIG. 2 is a schematic diagram of another embodiment of the solid-state lithium battery 200 of the present disclosure. The second electrode layer structure 230 of the solid-state lithium battery 200 includes a second buffer electrolyte layer 232 and a second microporous electrode layer 234. The second buffer electrolyte layer 232 is located between the second microporous electrode layer 234 and the second surface 114 of the solid electrolyte layer 110. The second buffer electrolyte layer 232 is embedded with the second surface 114 of the solid electrolyte layer 110, wherein the second buffer electrolyte layer 232 and the first buffer electrolyte layer 122 are having the same function. The second buffer electrolyte layer 232 can be embedded with the second surface 114 of the solid electrolyte layer 110 by coating or pasting. The instant disclosure applies the use of the first buffer electrolyte layer 122 and the second buffer electrolyte layer 232 to connect with the first microporous electrode layer 124 and the solid electrolyte layer 110, and the function of the ion channel of the second microporous electrode layer 234 to strengthen the prevention of the solid electrolyte layer 110 from reacting with the active material of which results in the formation of a high-impedance solid electrolyte layer 110 interface. By thus, it can also prevent the active material from leading the formation of lithium dendrites during charging/discharging process to penetrate the layer resulting in a short circuit. Basing on the above-mentioned, the solid-state lithium battery 200 of the instant disclosure can be charged, discharged and used under regular temperature and pressure. The structure of the first microporous electrode layer 124 and the second microporous electrode layer 234 can retain the ion channel unblocked and maintain the battery performance when the battery body is expanding or shrinking due to charge/discharge process. In addition, in one embodiment, the thickness H1 of the first microporous electrode layer 124 is greater than five times the thickness H3 of the second microporous electrode layer 234, so that the overall capacitance density can be increased.

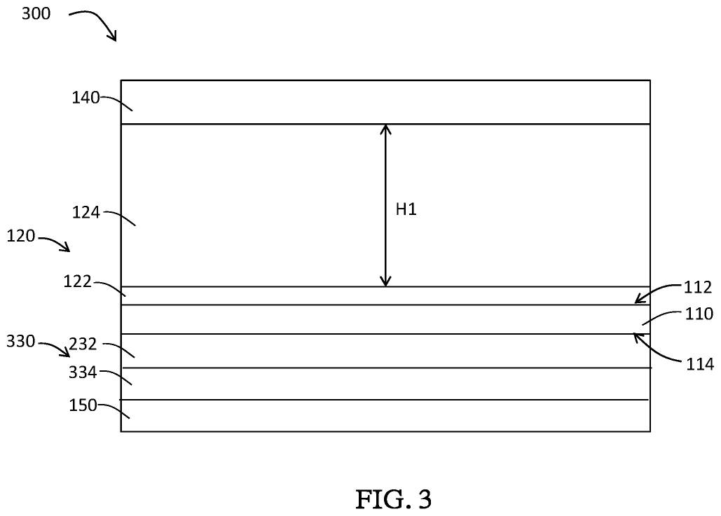

In one embodiment, the second microporous electrode layer 234 can include active metal(s), wherein the active metal(s) can be lithium, potassium, sodium, or magnesium. In other embodiments, the second microporous electrode layer 234 does not contain active metal. The active metal containment is adjustable in accordance with the condition applied. The instant invention is not limited to the second electrode layer structure. As shown in FIG. 3, the second electrode layer structure 330 of the solid-state lithium battery 300 in FIG. 3 includes a second buffer electrolyte layer 232 and an active metal electrode layer 334. The second buffer electrolyte layer 232 is located between the active metal electrode layer 334 and the second surface 114 of the solid electrolyte layer 110. The active metal electrode layer 334 includes active metal(s), such as lithium, potassium, sodium, or magnesium.

In one embodiment, the thicknesses of the first buffer electrolyte layer 122 and the second buffer electrolyte layer 232 are less than 5 μm, and the thickness of the solid electrolyte layer 110 is less than 100 μm.

In one embodiment, the first buffer electrolyte layer 122 and the second buffer electrolyte layer 232 respectively include an electrolyte material, wherein the electrolyte material of the first buffer electrolyte layer 122 and the electrolyte material of the second buffer electrolyte layer 232 can be the same. However, in another embodiments, the electrolyte material of the first buffer electrolyte layer 122 and the electrolyte material of the second buffer electrolyte layer 232 can be different. The electrolyte material is a polymer gel electrolyte, so the first buffer electrolyte layer 122 has softness and high adhesion. That is to say, the first buffer electrolyte layer 122 and the second buffer electrolyte layer 232 in the instant disclosure possess plasticity and flexibility at room temperature and have better contact, and are more suitable as a part of the battery structure. Therefore, the morphology of both the first buffer electrolyte layer 122 and the second buffer electrolyte layer 232 respectively embedded with the first surface 112 and the second surface 114 of the solid electrolyte layer 110 can be changed according to the morphology of the electrode sheet within the temperature range of 0° C. to 90° C., which is highly adjustable.

In one embodiment, the first buffer electrolyte layer 122 and the second buffer electrolyte layer 232 respectively include an ion-conductive material, leading that the buffer layer of the instant disclosure (such as the first buffer electrolyte layer 122 or the second buffer electrolyte layer 232 in FIG. 2 and FIG. 3) has the function of conducting ions, wherein the ion-conductive material of the first buffer electrolyte layer 122 and the ion-conductive material of the second buffer electrolyte layer 232 can be the same. In other embodiments, the ion-conductive material of the first buffer electrolyte layer 122 and the ion-conductive material of the second buffer electrolyte layer 232 can be different.

In one embodiment, the second buffer electrolyte layer 232 can be a hot-melt type ion-conducting polymer gel electrolyte. With regard to the material of the hot-melt type ion-conductive polymer gel electrolyte, please refer to that of the first buffer electrolyte layer 122 in the aforementioned description. In other embodiments, the second buffer electrolyte layer 232 can be a solvent type ion-conductive polymer gel electrolyte. With regard to the material of the solvent type ion-conductive polymer gel electrolyte please refer to that of the first buffer electrolyte layer 122 in the aforementioned description.

In one embodiment, the first buffer electrolyte layer 122 and the second buffer electrolyte layer 232 respectively include a flame retardant substance, so that the solid-state lithium battery 200 in FIG. 2 or the solid-state lithium battery 300 in FIG. 3 of the instant disclosure possess a flame retardant property.

The aforementioned first buffer electrolyte layer 122 and the second buffer electrolyte layer 232 with the flame retardant substance are prepared by the method as follows: firstly, preparing a first solution with a high boiling point solvent.

In one embodiment, preparing the first solution with a high boiling point solvent includes the following steps: using lithium salt solid or lithium salt solution as the lithium salt material. Besides, a solvent with a boiling point above 200° C. under 1 atm is used as a high boiling point solvent. Compare with a low boiling point co-solvent, the high boiling point solvent can be able to dissolve the solid polymer material at a temperature greater than 100° C. to form the second solution, while the low boiling point co-solvent assists the solid polymer material to dissolve into a pre-solution at a temperature lower than 100° C. In addition, the high boiling point solvent can also help the metal ions in the first buffer electrolyte layer 122 and the second buffer electrolyte layer 232 to transfer and move between the positive and negative electrodes. Wherein the high boiling point solvent containing sulfur accounts for 50%˜100% by weight of the high boiling point solvent, and the melting point of the sulfur-containing high boiling point solvent is greater than 25° C. and the boiling point is greater than 250° C. under 1 atm. Next, the high boiling point solvent and the lithium salt material are mixed and heated at a temperature ranging from 20° C. to 150° C. to uniformly form a first solution.

Next, after preparing the first solution with a high boiling point solvent, a solid polymer material is added and mixed into the first solution, and followed with a heating and stirring step to form a second solution. The solid polymer material is an organic material, so the second solution after heating and stirring forms a viscous body with the organic material. In the instant embodiment, the solid polymer material can be, for example, polyethylene oxide (PEO), polypropylene oxide (PPO), polysiloxanes, polyacrylonitrile (PAN), polymethyl methacrylate (PMMA), polyvinyl chloride (PVC), polyvinylidene fluoride (PVDF) or poly(vinylidene fluoride-co-hexafluoropropylene) (PVDF-HFP), etc., but not to limit the instant invention.

In one embodiment, the steps of adding the solid polymer material into the first solution and performing the heating and stirring step to form the second solution include the following steps: using a solvent having a boiling point below 100° C. under 1 atm as a low boiling point co-solvent. Next, a heating and stirring step is first performed to uniformly mix the solid polymer material and the low boiling co-solvent in order to form a pre-solution with the low boiling point co-solvent. The pre-solution is then added into the first solution and mixed uniformly to form the second solution. For example, in one embodiment, the weight percentage of the solid polymer material in the second solution is 6%-40%, and the weight of the solid polymer material is 20%-60% of the weight of the high boiling point solvent. The weight percentage of low boiling point co-solvent in the second solution is 1%-80%.

After forming the second solution, then, add a flame retardant ion-conductive materials and a water absorbent flame retardant materials into the second solution to mix uniformly to form a third solution. In detail, the above-mentioned step further includes the following steps: use materials that can increase the ion-conductivity of the electrolyte as a flame retardant ion-conductive material. In other words, the flame retardant ion-conductive material can increase the ion conductivity of the electrolyte. In this embodiment, the flame retardant ion-conductive materials include, for example, silicon-containing oxides, lithium-containing sulfur oxides, lithium-containing sulfur-tin oxides, lithium-containing sulfides, lithium-containing oxides, trimethyl phosphite (TMPI), trimethyl phosphate (TMP), core shell etc. The flame retardant ion-conductive materials are particles with a size of about 10 nm˜1 μm. Next, use a water absorption greater than 0.1 g/g per unit weight as a water absorbent flame retardant material. The water absorbent flame retardant materials are particles with a size of about 1 nm˜1 μm. The characteristic of the water absorbent flame retardant material is that it only absorbs water and does not absorb high boiling point solvents or low boiling point co-solvents. In one embodiment, the weight percentage of the flame retardant ion-conductive material in the third solution is 1%-90%, and the weight percentage of the water absorbent flame retardant in the third solution is 0.01%-20%.

Next, turn the third solution into a viscous body. In particular, after heating and stirring, the third solution is turned into a viscous body with a viscosity greater than 200 centipoise (cps) at the temperature above 25° C. The use of the low boiling point co-solvent can help to reduce the dissolution temperature of the solid polymer material used to make the above-mentioned viscous body. The above-mentioned the second solution is a viscous body containing organic materials and the flame retardant ion-conductive materials are inorganic, so, after heating and stirring, the third solution is turned into a viscous body containing both organic materials and inorganic materials.

Next, solidify the viscous body to form a flame retardant ion-conductive gel solid electrolyte film. In detail, the step of solidifying the viscous body includes the following steps: cooling the viscous body, removing the low boiling point co-solvents, and solidifying the viscous body to make it become a flame retardant ion-conductive gel solid electrolyte film. It can be seen that the viscous body can be turned into a flame retardant ion-conductive gel solid electrolyte film by cooling to serve as the first buffer electrolyte layer 122 and the second buffer electrolyte layer 232. In addition, the low boiling point co-solvent can be volatilized at room temperature, so that the low boiling point co-solvent is also removed during the process of cooling the viscous body.

In one embodiment, the first microporous electrode layer 124 and the second microporous electrode layer 234 respectively include oxides containing lithium and transition metals. The second microporous electrode layer 234 can be formed on the second buffer electrolyte layer 232 by coating or spraying, and both the second microporous electrode layer 234 and the first microporous electrode layer 124 have a structure with a plurality of micropores.

In summary, the instant disclosure applies the use of the buffer electrolyte layer (such as the first buffer electrolyte or the second buffer electrolyte) to connect with the first microporous electrode layer 124 and the solid electrolyte layer 110, and the function of the ion channel of the second electrode layer structure 130 to prevent the solid electrolyte layer 110 from reacting with the active material of which results in the formation of a high-impedance solid electrolyte layer 110 interface. By thus, it can also prevent the active material from leading the formation of lithium dendrites during charging/discharging process to penetrate the layer resulting in a short circuit. In other words, the use of the first buffer electrolyte layer 122 can solve the problem of high-impedance interface of the solid electrolyte layer 110, so there is no need to charge/discharge the solid-state lithium battery 100 under high temperature or high pressure conditions. The solid-state lithium battery 100 of the instant disclosure can be charged, discharged and used under regular temperature and pressure.

In addition, the structure of the microporous electrode layer (such as the first microporous electrode layer 124 or the second microporous electrode layer 234) can retain the ion channel unblocked and maintain the battery performance when the battery body is expanding or shrinking due to charge/discharge process.

In addition, the disclosed solid-state lithium battery possesses a flame retardant characteristics, and can be charged, discharged and used under regular temperature and pressure, thereby improving the efficiency of usage.

With respect to the above description, those embodiments are exemplary only, not limiting. It is to be realized that any equivalent modification should be deemed readily apparent and obvious to one skilled in the art. All equivalent relationships to those illustrated in the drawings and described in the specification are intended to be encompassed by the instant disclosure.

What is claimed is:

1. A solid-state lithium battery, comprising:
a solid electrolyte layer, comprising a first surface and a second surface opposite to each other;
a first electrode layer structure, comprising:
a first buffer electrolyte layer being embedded with the first surface of the solid electrolyte layer; and
a first microporous electrode layer, wherein the first buffer electrolyte layer is located between the first microporous electrode layer and the first face of the solid electrolyte layer;
a second electrode layer structure, disposing on the second surface of the solid electrolyte layer;
a first collector layer, wherein the first microporous electrode layer is disposed between the first collector layer and the first buffer electrolyte layer; and
a second collector layer, wherein the second electrode layer structure is disposed between the second collector layer and the second surface of the solid electrolyte layer.

2. The solid-state lithium battery of claim 1, wherein the first buffer electrolyte layer further comprises an electrolyte material.

3. The solid-state lithium battery of claim 2, wherein the electrolyte material is a polymer gel electrolyte.

4. The solid-state lithium battery of claim 1, wherein the first buffer electrolyte layer further comprises an ion-conductive material.

5. The solid-state lithium battery of claim 1, wherein the first buffer electrolyte layer further comprises a flame retardant substance.

6. The solid-state lithium battery of claim 1, wherein the second electrode layer structure is an electrode layer.

7. The solid-state lithium battery of claim 1, wherein a thickness of the first microporous electrode layer is greater than five times a thickness of the second electrode layer structure.

8. The solid-state lithium battery of claim 1, wherein the first buffer electrolyte layer is a hot-melt type ion-conductive polymer gel electrolyte.

9. The solid-state lithium battery of claim 1, wherein the first buffer electrolyte layer is a solvent type ion-conductive polymer gel electrolyte.

10. The solid-state lithium battery of claim 1, wherein the second electrode layer structure further comprises a second buffer electrolyte layer, and the second buffer electrolyte layer is embedded with the second surface of the solid electrolyte layer.

11. The solid-state lithium battery of claim 10, wherein the second electrode layer structure further comprises an active metal electrode layer, and the second buffer electrode layer is located between the active metal electrode layer and the second surface of the solid electrolyte layer.

12. The solid-state lithium battery of claim 10, wherein the second electrode layer structure further comprises a second microporous electrode layer, and the second buffer electrolyte layer is located between the second microporous electrode layer and the second surface of the solid electrolyte layer.

13. The solid-state lithium battery of claim 12, wherein the second microporous electrode layer further including an active metal.

14. The solid-state lithium battery of claim 12, wherein the thickness of the first microporous electrode layer is greater than five times the thickness of the second electrode layer structure.

15. The solid-state lithium battery of claim 10, wherein the first buffer electrolyte layer and the second buffer electrolyte layer respectively further comprise an electrolyte material.

16. The solid-state lithium battery of claim 15, wherein the electrolyte material of the first buffer electrolyte layer is identical to the electrolyte material of the second buffer electrolyte layer.

17. The solid-state lithium battery of claim 15, wherein the electrolyte material of the first buffer electrolyte layer is different from the electrolyte material of the second buffer electrolyte layer.

18. The solid-state lithium battery of claim 15, wherein the electrolyte material of the first buffer electrolyte layer and the electrolyte material of the second buffer electrolyte layer are respectively a polymer gel electrolyte.

19. The solid-state lithium battery, wherein the first buffer electrolyte layer and the second buffer electrolyte layer respectively further comprise an ion-conductive material.

20. The solid-state lithium battery of claim 19, wherein the ion-conductive material of the first buffer electrolyte layer is identical to the ion-conductive material of the second buffer electrolyte layer.

21. The solid-state lithium battery of claim 19, wherein the ion-conductive material of the first buffer electrolyte layer is different from the ion-conductive material of the second buffer electrolyte layer.

22. The solid-state lithium battery of claim 10, wherein the first buffer electrolyte layer and the second buffer electrolyte layer respectively further comprise a flame retardant substance.

23. The solid-state lithium battery of claim 10, wherein the second buffer electrolyte layer is a hot-melt type ion-conductive polymer gel electrolyte.

24. The solid-state lithium battery of claim 10, wherein the second buffer electrolyte layer is a solvent type ion-conductive polymer gel electrolyte.

25. The solid-state lithium battery of claim 1, wherein the first microporous electrode layer further comprises an oxide containing lithium and transition metal.

26. The solid-state lithium battery of claim 12, wherein the second microporous electrode layer further comprises an oxide containing lithium and transition metal.
